(19) United States
(12) Patent Application Publication
(10) Pub. No.: US 2010/0320642 A1
(43) Pub. Date: Dec. 23, 2010

(54) APPARATUS AND METHOD FOR TAKING UP, POSITIONING AND DRAPING DRY TEXTILE FIBER SEMI-FINISHED PRODUCTS

(75) Inventors: Christian Weimer, Munchen (DE); Nikolaus Batge, Deisenhofen (DE); Marco Gottinger, Munchen (DE)

Correspondence Address: BROOKS KUSHMAN P.C., 1000 TOWN CENTER, TWENTY-SECOND FLOOR, SOUTHFIELD, MI, 48075, US

(73) Assignee: EUROCOPTER DEUTSCHLAND GMBH, Donauworth (DE)

(21) Appl. No.: 12/819,409

(22) Filed: Jun. 21, 2010

(30) Foreign Application Priority Data
Jun. 22, 2009 (EP) 09 400030.4

(51) Int. Cl. B25J 15/06; B32B 37/02

(52) U.S. Cl. 264/258; 294/64.1

(57) ABSTRACT

The invention relates to an apparatus (10) for taking up, positioning and draping dry textile fiber semi-finished products (34) and comprises a housing (12) with an open housing side, a membrane (14) disposed inside the housing (12) and running parallel to the open housing side, which divides the housing (12) into a first upper chamber (16) and a second lower chamber (18), as well as at least one fluid guidance opening (22, 24) disposed in the first chamber (16) for pressure control in the upper chamber and for supplying and removing a heatable fluid into the upper chamber (18). The membrane (14) is formed from a flexible and fluid-tight material and the membrane (14) comprises a plurality of suction heads (26) directed into the lower chamber (18), the suction heads (26) being connected via a flexibly configured suction line (30) guided through the upper chamber (16) to a vacuum shaft.

### CROSS REFERENCE TO RELATED APPLICATIONS

This application claims the benefit of EP 09 400030.4 dated Jun. 22, 2009, the disclosure of which is incorporated herein by reference.

### FIELD OF THE INVENTION

The invention relates to an apparatus and the method for taking up, positioning and draping dry textile fiber semi-finished products.

### BACKGROUND OF THE INVENTION

It is known that at the present time, the handling and draping of dry textile fiber semi-finished products takes place manually. In this case, the activation of a binder takes place in a second separate step.

Vacuum gripping systems for dry textile fiber semi-finished products have been developed in the nationally promoted research project LuFo II, “ProCFK”, “ProTex” part project, see A. S. Herrmann, M. Book, G. Ressler, J. Piepenbrock, Pro-CFK composite project, Proceedings of the DGLR Conference 2004, 041. A demonstrator was implemented which was able to show the handling of dry textile fibre semi-finished products. Automation of this technology was carried out on the Airbus by applying the gripping systems to a robot system.

Further gripping systems for chain-linking were developed with the Lower Saxony Project “AUTO-RTM”, see also U. Ebert, AUTO-RTM, Concept for high-automated process chain for the production of RTM-compound-components in large series, 3rd International Symposium on Composites Manufacturing Technology for Aircraft Structures, Markenesse 2006.

EP 0577505 (A1) discloses an installation for the production of multilayer structures made of composite materials, by draping pre-cut elementary layers over a forming dye, comprising in addition to the forming dye, a gripping tool capable of being mounted on an articulated arm of a robot. The forming dye comprises a flexible membrane, equipped with suckers which grip the pre-cut elementary layers. A vacuum circuit enables the membrane to be pressed up against a counter-shape placed behind the latter, in order to shape the elementary layer picked up. When the tool is brought onto the dye, a pressure source acts on the membrane in order to compact the elementary layer on the die.

FR 2667013 (A1) discloses a tool for the moulding of a part made from composite material, comprising a rigid mould cavity, a cover fastened to the mould cavity, and a ram constituted by a deformable wall, contained inside the mould cavity and including a rim gripped between the mould cavity and the lid. The wall of the ram is preformed and has an external shape complementary to the internal shape of the part to be produced; the ram, after the gripping of its rim between the mould cavity and the lid, defines an inflatable chamber. A conduit for the inlet of a pressurised fluid into the chamber emerges in the face of the lid defining the chamber. One application is the production of a mould for parts made of resin reinforced with reinforcing fibers.

Integration of real process chain elements into the circuit systems for binder activation and/or pressure control for reforming or targeted draping is not known.

### SUMMARY OF THE INVENTION

One embodiment of the disclosed apparatus for taking up, positioning and draping dry textile fiber semi-finished products comprises a housing with an open housing side, a membrane disposed inside the housing and running parallel to the open housing side, which divides the housing into a first chamber and a second chamber, as well as at least one fluid guidance opening disposed in the first chamber for pressure control in the second chamber and for supplying and removing a heatable fluid into the second chamber.

The membrane dividing the housing into the first and second chamber is formed from a flexible and fluid-tight membrane and comprises a plurality of suction heads directed into the second chamber which are connected via flexibly configured suction lines guided through the first chamber to a vacuum source. By using the double chamber system with flexible second chamber, it is now advantageously possible to achieve a deformation of a textile structure and at the same time achieve binder activation and stabilisation of a binder by means of the first chamber, e.g. by using a heatable fluid.

Thus, the handling, draping and activation of a binder in one step is now made possible for the first time by an embodiment according to the invention. In contrast to the prior art, “manual handling” is no longer necessary.

Further advantages include the reduction in specific production means due to the component-independent operating mode, the now-defined draping process, the reduction in process steps and process times due to the “inline” preform binder activation during handling of the layers and the capacity for automation and chain-linking.

In its side facing the second chamber, hereinafter designated as underside of the membrane, the membrane preferably has indentations aligned in the direction of the first chamber in the area of the suction heads. The formation of the indentations in the underside of the chamber in the area of the suction heads proves to be advantageous since the area to be evacuated is thereby configured to be enlarged in the area of the suction heads, thus ensuring improved take-up of the dry textile fiber semi-finished product.

According to a further embodiment of the invention, the membrane has local elevations and/or indentations in its underside. These local elevations and/or indentations form special draping zones, with the result that targeted draping is possible.

According to a further embodiment of the invention, the housing has a seal in the area of the open housing side. This has the effect of improved evacuation in the edge zone, i.e. the take-up and handing of the textile fiber semi-finished product is made easier.

The membrane is preferably made of an addition-cross-linking silicone rubber. The formation of the membrane from this is found to be advantageous since these materials have high extensibilities and temperature resistances.

According to a method for taking up, positioning and draping dry textile fiber semi-finished products, the apparatus according to the invention is initially positioned above a textile fiber semi-finished product. The textile fiber semi-finished product is then taken up by producing a vacuum at the suction heads. In a following process step, the textile fiber semi-finished product is positioned above a mould core and in a subsequent process step the textile fiber semi-finished product is draped over the mould core. In a last step the binder activation takes place by supplying a heated fluid via the fluid guidance opening into the first chamber.

### BRIEF DESCRIPTION OF THE DRAWINGS

Further advantages, features and possible applications of the present invention are obtained from the following description in conjunction with the exemplary embodiment shown in the drawings.

The invention is described in detail hereinafter with reference to the exemplary embodiment shown in the drawing.

In the drawings:

FIG. 1 shows a schematic diagram of the apparatus according to the invention;

FIG. 2 shows a plan view of the underside of the membrane with the distributed suction heads;

FIG. 3 shows an enlarged view of a suction head from FIG. 2 and

FIG. 4 shows a schematic diagram of the functioning principle of the apparatus according to the invention.

### DETAILED DESCRIPTION OF THE PREFERRED EMBODIMENT

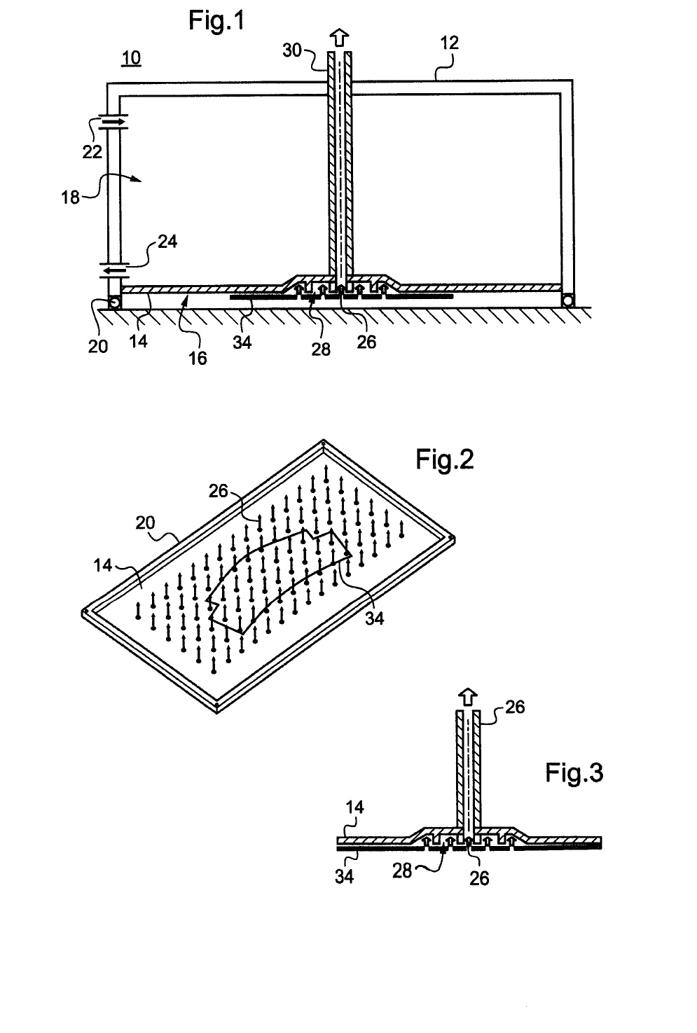

FIG. 1 shows more or less schematically an apparatus designated overall with the reference numeral 10 for taking up, positioning and draping dry fiber semi-finished products 12.

The apparatus 10 substantially consists of a housing 12 with an open housing side and a membrane 14 disposed in the housing 12 which divides the housing 12 into a first upper chamber 16 and a second lower chamber 18. A peripheral seal 20 is disposed in the area of the open housing side.

Furthermore, the first chamber 16 has two fluid guidance openings 22, 24 for supplying and removing a heatable fluid. In addition to the supply and removal of heatable fluid, the openings 22, 24 additionally also are for controlling pressure in the first chamber 16. The components required for pressure control such as, for example, pressure source, control and regulating unit etc. are not shown for reasons of clarity.

The membrane 14 is in this case made of an addition-cross-linking silicone rubber and is therefore flexible and fluid-tight and, as is particularly apparent from FIG. 2, has a plurality of suction heads 26 aligned into the second chamber 18 in its underside, i.e. in the side facing the second chamber 18. As is particularly apparent from FIG. 3, in the area of a suction head 26 on its underside the membrane 14 has an indentation 28 aligned in the direction of the first chamber 16.

The suction heads 26 are each operatively connected to a vacuum source via a suction line 30 guided through the first chamber 16 and configured to be flexible. The vacuum source was not shown in the present case for reasons of clarity.

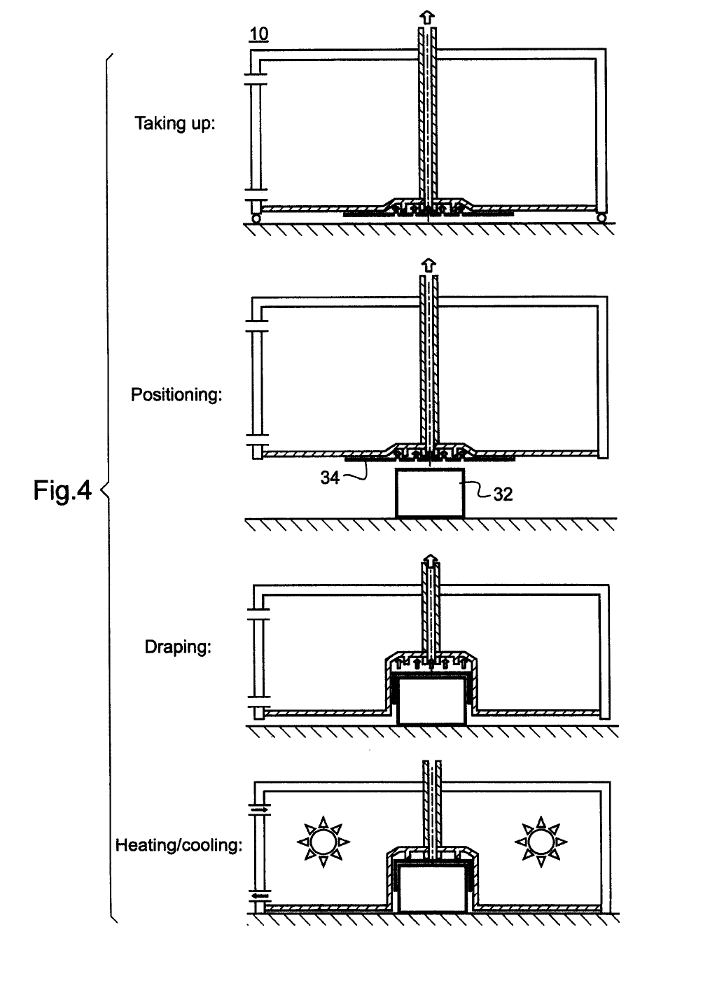

The function of the apparatus 10 according to the invention is shown in FIG. 4:

For taking up the textile fiber semi-finished product 12, the apparatus 10 is positioned over the textile fiber semi-finished product 34. Then a vacuum is generated via the suction line 30 in the area of the suction heads 26 and the indentations 28. By this means the textile fiber semi-finished product 34 is taken up and can be transported and positioned with the apparatus.

After positioning the textile fiber semi-finished product 12, e.g. over a mould core 32, draping of the textile fiber semi-finished product 12 takes place due to a corresponding pressure control in the first chamber 16.

In the following last step a heated fluid is supplied to the first chamber 16 for binder activation via the fluid supply openings 22, 24.

### REFERENCE LIST

10 Apparatus for taking up, positioning and draping
12 Housing
14 Membrane
16 First chamber
18 Second chamber
20 Seal
22 Fluid supply opening
24 Fluid supply opening
26 Suction head
28 Indentation
30 Suction line
32 Mould core
34 Fiber semi-finished product

1. An apparatus for taking up, positioning and draping dry textile fiber semi-finished products comprising:
a housing with an open housing side;
a membrane disposed inside the housing and running parallel to the open housing side, which divides the housing into a first chamber and a second chamber, as well as
at least one fluid guidance opening disposed in the first chamber for pressure control in the second chamber and for supplying and removing a heatable fluid into the second chamber,
wherein the membrane is formed from a flexible and fluid-tight material and the membrane comprises a plurality of suction heads directed into the second chamber which are connected via flexibly configured suction lines guided through the first chamber to a vacuum source.

2. The apparatus according to claim 1, wherein the membrane has indentations aligned in the direction of the first chamber in the area of the suction heads.

3. The apparatus according to claim 1, wherein the membrane has local elevations and/or indentations.

4. The apparatus according to claim 1, wherein the housing has a seal in the area of the open housing side.

5. The apparatus according to claim 1, wherein the membrane includes an addition-cross-linking silicone rubber.

6. A method for taking up, positioning and draping dry textile fiber semi-finished products according to claim 1, comprising the steps of:
positioning the apparatus of claim 1 above a textile fiber semi-finished product;
taking up the textile fiber semi-finished product by producing a vacuum at the suction heads;
positioning the textile fiber semi-finished product above a mould core;
draping the textile fiber semi-finished product; and
activating a binder activation by supplying a heated fluid via the fluid guidance opening into the first chamber.
